(19) United States
(12) Patent Application Publication
(10) Pub. No.: US 2022/0298014 A1
(43) Pub. Date: Sep. 22, 2022

(54) PROCESS

(71) Applicant: Oxford University Innovation Limited, Oxtord (GB)

(72) Inventors: Peter Philip EDWARDS, Oxford (GB); Tiancun XIAO, Oxford (GB); Xiangyu JIE, Oxford (GB)

(21) Appl. No.: 17/626,833

(22) PCT Filed: Jul. 23, 2019
(86) PCT No.: PCT/GB2019/052062

§ 371 Date: Jan. 13, 2022

(51) Int. Cl. C01B 3/26; B01J 23/745; B01J 27/224; B01J 21/18; B01J 8/06; H01M 8/0612

(52) U.S. Cl. CPC C01B 3/26; B01J 23/745; B01J 27/224; B01J 21/18; B01J 8/065; H01M 8/0612; C01B 2203/0277; C01B 2203/1047; C01B 2203/1082; C01B 2203/1241; H01M 2250/20

(57) ABSTRACT

The present invention provides a process for producing a gaseous product comprising hydrogen, said process comprising exposing a gaseous hydrocarbon to microwave radiation in the presence of a solid catalyst, wherein the catalyst comprises at least one iron species supported on a support comprising a ceramic material or carbon, or a mixture thereof. Also provided are a heterogeneous mixture comprising a solid catalyst in intimate mixture with a gaseous hydrocarbon wherein the catalyst comprises at least one iron species supported on a support comprising a ceramic material or carbon, or mixture thereof. Also provided are the use of said mixture to produce hydrogen, a microwave reactor comprising said mixture and a a fuel cell module comprising a (i) a fuel cell and (ii) a heterogeneous mixture as described herein, and a vehicle or electronic device comprising said fuel cell module.

### INTRODUCTION

The present invention relates to a process for producing a gaseous product comprising hydrogen from gaseous hydrocarbons. In particular, the process of the present invention provides a catalytic process for the decomposition of gaseous hydrocarbons to provide high purity hydrogen gas, suitably with minimal carbon by-products (such as CO₂, CO and small hydrocarbons).

### BACKGROUND OF THE INVENTION

Today, the world's ever-increasing energy demand is still based almost exclusively on fossil fuels, not only because of their unrivalled energy-carrying properties but also because of the demands of the world-wide energy infrastructure which has developed over the past century.

Hydrogen is regarded as one of the key energy solutions for the future (1-5), not only because of its intensive energy density per unit-mass, but also because its combustion produces no environmentally harmful carbon dioxide. Hence the problem of capturing this by-product is circumvented (1-5).

However, the cost of hydrogen production, delivery, and storage systems are major barriers that hinder the development of hydrogen-based economy (1, 6-12). The most efficient and widely used process so far for the production of hydrogen in industry is based on fossil fuel, for example by steam reforming or partial oxidation of methane and to a lesser degree by gasification of coal (3, 12-14). However, like combustion of hydrocarbons, all these conventional options of hydrogen production from hydrocarbons involve CO₂ production, which is environmentally undesirable. Therefore, technologies like Carbon Capture and Storage (CCS) and Carbon Capture and Utilization (CCU) are needed to control the CO₂ level (1, 15).

Solar energy can be used to yield increasing amounts of hydrogen by the splitting of water, but even if the photocatalytic or electrolytic breakdown of water could be greatly improved to produce large quantities of hydrogen, the question of its safe storage and rapid release for immediate use in applications such as fuel cells, for example, would still be problematic (1, 12).

There is a need for an in-situ process for the rapid release of high purity hydrogen from a suitable hydrogen containing material without the generation of environmentally harmful carbon dioxide.

Recent developments have seen the use of wax or liquid hydrocarbons as hydrogen storage materials to rapidly release hydrogen-rich gases through a microwave assisted catalytic decomposition (16, 17).

The present invention seeks to provide a simple and compact technology for in-situ hydrogen generation from a gaseous hydrocarbon. The present invention aims to provide high purity hydrogen with minimal production of carbon dioxide.

### SUMMARY OF THE INVENTION

The present invention provides a simple and compact process for the production of hydrogen from gaseous hydrocarbons using the assistance of microwaves. This allows the production of highly pure hydrogen with minimal carbon by-products (such as CO₂, CO and small hydrocarbons).

Accordingly, in a first aspect the present invention provides a process for producing a gaseous product comprising hydrogen, said process comprising exposing a gaseous hydrocarbon to microwave radiation in the presence of a solid catalyst, wherein the catalyst comprises at least one iron species supported on a support comprising a ceramic material or carbon, or mixture thereof.

In a second aspect, the present invention provides a heterogeneous mixture comprising a solid catalyst in intimate mixture with a gaseous hydrocarbon wherein the catalyst comprises at least one iron species supported on a support comprising a ceramic material or carbon, or mixture thereof.

In a third aspect, the present invention provides the use of a heterogeneous mixture of the second aspect for generating hydrogen.

In a fourth aspect, the present invention provides a microwave reactor comprising a heterogeneous mixture, said mixture comprising a solid catalyst in intimate mixture with a gaseous hydrocarbon, wherein the catalyst comprises at least one iron species supported on a support comprising a ceramic material or carbon, or mixture thereof.

In a fifth aspect, the present invention provides a fuel cell module comprising a (i) a fuel cell and (ii) a heterogeneous mixture comprising a solid catalyst in intimate mixture with a gaseous hydrocarbon wherein the catalyst comprises at least one iron species supported on a support comprising a ceramic material or carbon, or mixture thereof.

Preferred, suitable, and optional features of any one particular aspect of the present invention are also preferred, suitable, and optional features of any other aspect.

### BRIEF DESCRIPTION OF THE DRAWINGS

FIG. 1 shows the results of methane dehydrogenation under microwave irradiation over a 5 wt. % Fe/SiC catalyst. Hydrogen selectivity (vol. %) and methane conversion (%) were determined as a function of time with 750 W microwave input power at a gas flow of 20 ml/min.

FIG. 2 shows the results of methane dehydrogenation under microwave irradiation over a Fe—Al₂O₃—C catalysts (weight ratio: Fe:Al:C=65:30:5). Hydrogen selectivity (vol. %) and methane conversion (%) were determined as a function of time with 750 W microwave input power at a gas flow of 20 ml/min.

FIG. 3 shows an XRD pattern comparison of Fe—Al₂O₃—C catalyst before and after reaction.

FIG. 4 shows the SEM image of a prepared Fe—Al₂O₃—C catalyst.

FIGS. 5a and 5b show the SEM images of a spent Fe—Al₂O₃—C catalyst at different magnification.

### DETAILED DESCRIPTION OF THE INVENTION

### Definitions

As used herein the term “gaseous product” refers to a product which is gaseous at standard ambient temperature and pressure (SATP), i.e. at a temperature of 298.15 K (25° C.) and at 100,000 Pa (1 bar, 14.5 psi, 0.9869 atm).

As used herein the term “gaseous hydrocarbon” refers to a hydrocarbon which is gaseous at standard ambient temperature and pressure (SATP), i.e. at a temperature of 298.15 K (25° C.) and at 100,000 Pa (1 bar, 14.5 psi, 0.9869 atm). Examples include methane, ethane, propane and butane.

As used herein the term “hydrocarbon” refers to organic compounds consisting of carbon and hydrogen.

For the avoidance of doubt, hydrocarbons include straight-chained and branched, saturated and unsaturated aliphatic hydrocarbon compounds, including alkanes, alkenes, and alkynes, as well as saturated and unsaturated cyclic aliphatic hydrocarbon compounds, including cycloalkanes, cycloalkenes and cycloalkynes, as well as hydrocarbon polymers, for instance polyolefins.

Hydrocarbons also include aromatic hydrocarbons, i.e. hydrocarbons comprising one or more aromatic rings. The aromatic rings may be monocyclic or polycyclic.

Aliphatic hydrocarbons which are substituted with one or more aromatic hydrocarbons, and aromatic hydrocarbons which are substituted with one or more aliphatic hydrocarbons, are also of course encompassed by the term “hydrocarbon” (such compounds consisting only of carbon and hydrogen) as are straight-chained or branched aliphatic hydrocarbons that are substituted with one or more cyclic aliphatic hydrocarbons, and cyclic aliphatic hydrocarbons that are substituted with one or more straight-chained or branched aliphatic hydrocarbons.

A “Cₙ₋ₘ hydrocarbon” or “Cₙ-Cₘ hydrocarbon” or “On-Cm hydrocarbon”, where n and m are integers, is a hydrocarbon, as defined above, having from n to m carbon atoms. For instance, a C₁₋₁₅₀ hydrocarbon is a hydrocarbon as defined above which has from 1 to 150 carbon atoms, and a 05-60 hydrocarbon is a hydrocarbon as defined above which has from 5 to 60 carbon atoms.

The term “alkane”, as used herein, refers to a linear or branched chain saturated hydrocarbon compound. Examples of alkanes, are for instance, butane, pentane, hexane, heptane, octane, nonane, decane, undecane, dodecane, tridecane and tetradecane. Alkanes such as dimethylbutane may be one or more of the possible isomers of this compound. Thus, dimethylbutane includes 2,3-dimethybutane and 2,2-dimethylbutane. This also applies for all hydrocarbon compounds referred to herein including cycloalkane, alkene, cylcoalkene.

The term “cycloalkane”, as used herein, refers to a saturated cyclic aliphatic hydrocarbon compound. Examples of cycloalkanes include cyclopropane, cyclobutane, cyclopentane, cyclohexane, methylcyclopentane, cycloheptane, methylcyclohexane, dimethylcyclopentane and cyclooctane. Examples of a C₅₋₈ cycloalkane include cyclopentane, cyclohexane, methylcyclopentane, cycloheptane, methylcyclohexane, dimethylcyclopentane and cyclooctane. The terms “cycloalkane” and “naphthene” may be used interchangeably.

The term “alkene”, as used herein, refers to a linear or branched chain hydrocarbon compound comprising one or more double bonds. Examples of alkenes are butene, pentene, hexene, heptene, octene, nonene, decene, undecene, dodecene, tridecene and tetradecene. Alkenes typically comprise one or two double bonds. The terms “alkene” and “olefin” may be used interchangeably. The one or more double bonds may be at any position in the hydrocarbon chain. The alkenes may be cis- or trans-alkenes (or as defined using E- and Z-nomenclature). An alkene comprising a terminal double bond may be referred to as an “alk-1-ene” (e.g. hex-1-ene), a “terminal alkene” (or a “terminal olefin”), or an “alphaalkene” (or an “alpha-olefin”). The term “alkene”, as used herein also often includes cycloalkenes.

The term “cycloalkene”, as used herein, refers to partially unsaturated cyclic hydrocarbon compound. Examples of a cycloalkene includes cyclobutene, cyclopentene, cyclohexene, cyclohexa-1,3-diene, methylcyclopentene, cycloheptene, methylcyclohexene, dimethylcyclopentene and cyclooctene. A cycloalkene may comprise one or more double bonds.

The term “aromatic hydrocarbon” or “aromatic hydrocarbon compound”, as used herein, refers to a hydrocarbon compound comprising one or more aromatic rings. The aromatic rings may be monocyclic or polycylic. Typically, an aromatic compound comprises a benzene ring. An aromatic compound may for instance be a C₆₋₁₄ aromatic compound, a C₆₋₁₂ aromatic compound or a C₆₋₁₀ aromatic compound. Examples of C₆₋₁₄ aromatic compounds are benzene, toluene, xylene, ethylbenzene, methylethylbenzene, diethylbenzene, naphthalene, methylnaphthalene, ethylnaphthalene and anthracene.

As used herein “metal species” is any compound comprising a metal. As such, a metal species includes the elemental metal, metal oxides and other compounds comprising a metal, i.e. metal salts, alloys, hydroxides, carbides, borides, silicides and hydrides. When a specific example of a metal species is stated, said term includes all compounds comprising that metal, e.g. iron species includes elemental iron, iron oxides, iron salts, iron alloys, iron hydroxides, iron carbides, iron borides, iron silicides and iron hydrides for instance.

As used herein, the term “elemental metal” or specific examples such as “elemental Fe”, for example, refers to the metal only when in an oxidation state of zero.

Unless stated to the contrary, reference to elements by use of standard notation refers to said element in any available oxidation state. Similarly, wherein the term “metal” is used without further restriction no limitation to oxidation state is intended other than to those available.

As used herein, the term “transition metal” refers to an element of one of the three series of elements arising from the filling of the 3d, 4d and 5d shells. Unless stated to the contrary, reference to transition metals in general or by use of standard notation of specific transition metals refers to said element in any available oxidation state.

As used herein the term “ceramic material” refers to an inorganic material which is a compound of one or more metals or metalloids with one or more non-metals.

As used herein, the term “non-oxygenated ceramic material” refers to a ceramic material which does not contain an oxygen atom. Examples of non-oxygenated ceramic materials include carbides, borides, nitrides and silicides.

As used herein, the term “heterogeneous mixture” refers to the physical combination of at least two different substances wherein the two different substances are not in the same phase at standard ambient temperature and pressure (SATP), i.e. at a temperature of 298.15 K (25° C.) and at 100,000 Pa (1 bar, 14.5 psi, 0.9869 atm). For instance, one substance may be a solid and one substance may be a gas.

### Process

In one aspect the present invention relates to a process for producing a gaseous product comprising hydrogen, said process comprising exposing a gaseous hydrocarbon to microwave radiation in the presence of a solid catalyst, wherein the catalyst comprises at least one iron species supported on a support comprising a ceramic material or carbon, or a mixture thereof.

In one embodiment, the process produces a gaseous product comprising about 80 vol. % or more of hydrogen in the total amount of evolved gas. Suitably, about 85 vol. % or more of hydrogen in the total amount of evolved gas, more suitably about 90 vol. % or more of hydrogen, more suitably about 91 vol. % or more of hydrogen, more suitably about 92 vol. % or more of hydrogen, more suitably about 93 vol. % or more of hydrogen, more suitably about 94 vol. % or more of hydrogen, more suitably about 95 vol. % or more of hydrogen, more suitably about 96 vol. % or more of hydrogen, more suitably about 97 vol. % or more of hydrogen, more suitably about 98 vol. % or more of hydrogen, more suitably about 99 vol. % or more of hydrogen in the total amount of evolved gas.

In one embodiment, the process produces a gaseous product comprising about 80 vol. % to about 99 vol. % of hydrogen in the total amount of evolved gas. Suitably, about 85 vol. % to about 99 vol. % of hydrogen in the total amount of evolved gas, more suitably about 90 vol. % to about 99 vol. % of hydrogen, more suitably about 91 vol. % to about 99 vol. % of hydrogen, more suitably about 92 vol. % to about 99 vol. % of hydrogen, more suitably about 93 vol. % to about 99 vol. % of hydrogen, more suitably about 94 vol. % to about 99 vol. % of hydrogen, more suitably about 95 vol. % to about 99 vol. % of hydrogen, more suitably about 96 vol. % to about 99 vol. % of hydrogen, more suitably about 97 vol. % to about 99 vol. % of hydrogen, more suitably about 98 vol. % to about 99 vol. % of hydrogen in the total amount of evolved gas.

In one embodiment, the process produces a gaseous product comprising about 80 vol. % to about 98 vol. % of hydrogen in the total amount of evolved gas. Suitably, about 85 vol. % to about 98 vol. % of hydrogen in the total amount of evolved gas, more suitably about 90 vol. % to about 98 vol. % of hydrogen, more suitably about 91 vol. % to about 98 vol. % of hydrogen, more suitably about 92 vol. % to about 98 vol. % of hydrogen, more suitably about 93 vol. % to about 98 vol. % of hydrogen, more suitably about 94 vol. % to about 98 vol. % of hydrogen, more suitably about 95 vol. % to about 98 vol. % of hydrogen, more suitably about 96 vol. % to about 98 vol. % of hydrogen, more suitably about 97 vol. % to about 98 vol. % of hydrogen in the total amount of evolved gas.

In one embodiment, the process produces a gaseous product comprising about 10 vol. % or less of carbon dioxide in the total amount of evolved gas. Suitably, about 9 vol. % or less of carbon dioxide in the total amount of evolved gas, more suitably about 8 vol. % or less of carbon dioxide, more suitably about 7 vol. % or less of carbon dioxide, more suitably about 6 vol. % or less of carbon dioxide, more suitably about 5 vol. % or less of carbon dioxide, more suitably about 4 vol. % or less of carbon dioxide, more suitably about 3 vol. % or less of carbon dioxide, more suitably about 2 vol. % or less of carbon dioxide, more suitably about 1 vol. % or less of carbon dioxide, more suitably about 0.5 vol. % or less of carbon dioxide, more suitably about 0.3 vol. % or less of carbon dioxide in the total amount of evolved gas, more suitably about 0.2 vol. % or less of carbon dioxide in the total amount of evolved gas, more suitably about 0.1 vol. % or less of carbon dioxide in the total amount of evolved gas.

In one embodiment, the process produces a gaseous product comprising about 0.1 vol. % to about 10 vol. % of carbon dioxide in the total amount of evolved gas. Suitably, about 0.1 vol. % to about 9 vol. % of carbon dioxide in the total amount of evolved gas, more suitably about 0.1 vol. % to about 8 vol. % of carbon dioxide, more suitably about 0.1 vol. % to about 7 vol. % of carbon dioxide, more suitably about 0.1 vol. % to about 6 vol. % of carbon dioxide, more suitably about 0.1 vol. % to about 5 vol. % of carbon dioxide, more suitably about 0.1 vol. % to about 4 vol. % of carbon dioxide, more suitably about 0.1 vol. % to about 3 vol. % of carbon dioxide, more suitably about 0.1 vol. % to about 2 vol. % of carbon dioxide, more suitably about 0.1 vol. % to about 1 vol. % of carbon dioxide, more suitably about 0.1 vol. % to about 0.5 vol. % of carbon dioxide, more suitably about 0.1 vol. % to about 0.3 vol. % of carbon dioxide in the total amount of evolved gas, more suitably about 0.1 vol. % to about 0.2 vol. % of carbon dioxide in the total amount of evolved gas.

In one embodiment, the process produces a gaseous product comprising about 10 vol. % or less of carbon monoxide in the total amount of evolved gas. Suitably, about 9 vol. % or less of carbon monoxide in the total amount of evolved gas, more suitably about 8 vol. % or less of carbon monoxide, more suitably about 7 vol. % or less of carbon monoxide, more suitably about 6 vol. % or less of carbon monoxide, more suitably about 5 vol. % or less of carbon monoxide, more suitably about 4 vol. % or less of carbon monoxide, more suitably about 3 vol. % or less of carbon monoxide, more suitably about 2 vol. % or less of carbon monoxide, more suitably about 1 vol. % or less of carbon monoxide, more suitably about 0.5 vol. % or less of carbon monoxide, more suitably about 0.3 vol. % or less of carbon monoxide in the total amount of evolved gas, more suitably about 0.2 vol. % or less of carbon monoxide in the total amount of evolved gas, more suitably about 0.1 vol. % or less of carbon monoxide in the total amount of evolved gas.

In one embodiment, the process produces a gaseous product comprising about 0.2 vol. % to about 10 vol. % of carbon monoxide in the total amount of evolved gas. Suitably, about 0.2 vol. % to about 9 vol. % of carbon monoxide in the total amount of evolved gas, more suitably about 0.2 vol. % to about 8 vol. % of carbon monoxide, more suitably about 0.2 vol. % to about 7 vol. % of carbon monoxide, more suitably about 0.2 vol. % to about 6 vol. % of carbon monoxide, more suitably about 0.2 vol. % to about 5 vol. % of carbon monoxide, more suitably about 0.2 vol. % to about 4 vol. % of carbon monoxide, more suitably about 0.2 vol. % to about 3 vol. % of carbon monoxide, more suitably about 0.2 vol. % to about 2 vol. % of carbon monoxide, more suitably about 0.2 vol. % to about 1 vol. % of carbon monoxide, more suitably about 0.2 vol. % to about 0.5 vol. % of carbon monoxide, more suitably about 0.2 vol. % to about 0.3 vol. % of carbon monoxide in the total amount of evolved gas, more suitably about 0.2 vol. % to about 0.2 vol. % of carbon monoxide in the total amount of evolved gas.

In one embodiment, the process produces a gaseous product comprising about 10 vol. % or less of ethane in the total amount of evolved gas. Suitably, about 9 vol. % or less of methane in the total amount of evolved gas, more suitably about 8 vol. % or less of ethane, more suitably about 7 vol. % or less of ethane, more suitably about 6 vol. % or less of ethane, more suitably about 5 vol. % or less of ethane, more suitably about 4 vol. % or less of methane, more suitably about 3 vol. % or less of ethane, more suitably about 2 vol. % or less of ethane, more suitably about 1 vol. % or less of ethane, more suitably about 0.5 vol. % or less of ethane, more suitably about 0.3 vol. % or less of ethane in the total amount of evolved gas, more suitably about 0.2 vol. % or less of ethane in the total amount of evolved gas, more suitably about 0.1 vol. % or less of ethane in the total amount of evolved gas.

In one embodiment, the process produces a gaseous product comprising about 0.05 vol. % to about 10 vol. % of ethane in the total amount of evolved gas. Suitably, about 0.05 vol. % to about 9 vol. % of ethane in the total amount of evolved gas, more suitably about 0.05 vol. % to about 8 vol. % of ethane, more suitably about 0.05 vol. % to about 7 vol. % of ethane, more suitably about 0.05 vol. % to about 6 vol. % of ethane, more suitably about 0.05 vol. % to about 5 vol. % of ethane, more suitably about 0.05 vol. % to about 4 vol. % of ethane, more suitably about 0.05 vol. % to about 3 vol. % of ethane, more suitably about 0.05 vol. % to about 2 vol. % of ethane, more suitably about 0.05 vol. % to about 1 vol. % of ethane, more suitably about 0.05 vol. % to about 0.5 vol. % of ethane, more suitably about 0.05 vol. % to about 0.3 vol. % of ethane in the total amount of evolved gas, more suitably about 0.05 vol. % to about 0.2 vol. % of ethane in the total amount of evolved gas.

In one embodiment, the process produces a gaseous product comprising about 10 vol. % or less of ethylene in the total amount of evolved gas. Suitably, about 9 vol. % or less of ethylene in the total amount of evolved gas, more suitably about 8 vol. % or less of ethylene, more suitably about 7 vol. % or less of ethylene, more suitably about 6 vol. % or less of ethylene, more suitably about 5 vol. % or less of ethylene, more suitably about 4 vol. % or less of ethylene, more suitably about 3 vol. % or less of ethylene, more suitably about 2 vol. % or less of ethylene, more suitably about 1 vol. % or less of ethylene, more suitably about 0.5 vol. % or less of ethylene, more suitably about 0.3 vol. % or less of ethylene in the total amount of evolved gas, more suitably about 0.2 vol. % or less of ethylene in the total amount of evolved gas, more suitably about 0.1 vol. % or less of ethylene in the total amount of evolved gas.

In one embodiment, the process produces a gaseous product comprising about 0.05 vol. % to about 10 vol. % of ethylene in the total amount of evolved gas. Suitably, about 0.05 vol. % to about 9 vol. % of ethylene in the total amount of evolved gas, more suitably about 0.05 vol. % to about 8 vol. % of ethylene, more suitably about 0.05 vol. % to about 7 vol. % of ethylene, more suitably about 0.05 vol. % to about 6 vol. % of ethylene, more suitably about 0.05 vol. % to about 5 vol. % of ethylene, more suitably about 0.05 vol. % to about 4 vol. % of ethylene, more suitably about 0.05 vol. % to about 3 vol. % of ethylene, more suitably about 0.05 vol. % to about 2 vol. % of ethylene, more suitably about 0.05 vol. % to about 1 vol. % of ethylene, more suitably about 0.05 vol. % to about 0.5 vol. % of ethylene, more suitably about 0.05 vol. % to about 0.3 vol. % of ethylene in the total amount of evolved gas, more suitably about 0.05 vol. % to about 0.2 vol. % of ethylene in the total amount of evolved gas.

In one embodiment, the process produces a gaseous product comprising about 90 vol. % hydrogen or more and about 0.5 vol. % of carbon dioxide or less in the total evolved gas. Suitably, in this embodiment, the amount of carbon dioxide is 0.4 vol. % or less, more suitably 0.3 vol. % or less, more suitably 0.2 vol. % or less, more suitably 0.1 vol. % or less in the total evolved gas.

In one embodiment, the process produces a gaseous product comprising about 90 vol. % to about 98 vol. % hydrogen and about 0.5 vol. % of carbon dioxide or less in the total evolved gas. Suitably, in this embodiment, the amount of carbon dioxide is 0.4 vol. % or less, more suitably 0.3 vol. % or less, more suitably 0.2 vol. % or less, more suitably 0.1 vol. % or less in the total evolved gas.

In one embodiment, the process produces a gaseous product comprising about 90 vol. % to about 98 vol. % hydrogen and about 0.1 vol. % to about 0.5 vol. % of carbon dioxide in the total evolved gas.

In one embodiment, the process produces a gaseous product comprising about 90 vol. % to about 98 vol. % hydrogen and about 0.1 vol. % to about 0.5 vol. % of carbon dioxide and about 5 vol. % or less of carbon monoxide in the total evolved gas. Suitably, in this embodiment, the amount of carbon monoxide is 4 vol. % or less, more suitably 3 vol. % or less, more suitably 2 vol. % or less, more suitably 1 vol. % or less, more suitably 0.5 vol. % or less in the total evolved gas.

In one embodiment, the process produces a gaseous product comprising about 90 vol. % to about 98 vol. % hydrogen and about 0.1 vol. % to about 0.5 vol. % of carbon dioxide and about 0.2 vol. % to about 5 vol. % of carbon monoxide in the total evolved gas.

In one embodiment, the process produces a gaseous product comprising about 90 vol. % to about 98 vol. % hydrogen, and about 0.1 vol. % to about 0.5 vol. % of carbon dioxide, and about 0.2 vol. % to about 5 vol. % of carbon monoxide, and about 5 vol. % or less of ethylene in the total evolved gas. Suitably, in this embodiment, the amount of carbon monoxide is 4 vol. % or less, more suitably 3 vol. % or less, more suitably 2 vol. % or less, more suitably 1 vol. % or less, more suitably 0.5 vol. % or less in the total evolved gas.

In one embodiment, the process produces a gaseous product comprising about 90 vol. % to about 98 vol. % hydrogen and about 0.1 vol. % to about 0.5 vol. % of carbon dioxide and about 0.2 vol. % to about 5 vol. % of carbon monoxide and about 0.2 vol. % to about 5 vol. % of ethylene in the total evolved gas.

In one embodiment, the process produces a gaseous product comprising about 95 vol. % to about 98 vol. % hydrogen and about 0.1 vol. % to about 0.5 vol. % of carbon dioxide and about 0.2 vol. % to about 1 vol. % of carbon monoxide and about 0.2 vol. % to about 1 vol. % of ethylene in the total evolved gas.

In one embodiment, the process is carried out in an atmosphere substantially free of oxygen. Suitably, an atmosphere free of oxygen. In another embodiment, process comprises exposing the composition to microwave radiation in an atmosphere substantially free of oxygen, suitably free of oxygen.

In another embodiment, the process is carried out in an atmosphere substantially free of water. Suitably, an atmosphere free of water. In another embodiment, process comprises exposing the composition to microwave radiation in an atmosphere substantially free of water, suitably free of water.

In another embodiment, the process is carried out in an atmosphere substantially free of oxygen and water. Suitably, an atmosphere free of oxygen and water. In another embodiment, process comprises exposing the composition to microwave radiation in an atmosphere substantially free of oxygen and water, suitably free of oxygen and water.

In another embodiment, the process is carried out in an inert atmosphere. In another embodiment, process comprises exposing the composition to microwave radiation in an inert atmosphere.

The inert atmosphere may for instance be an inert gas or a mixture of inert gases. The inert gas or mixture of inert gases typically comprises a noble gas, for instance argon. In one embodiment the inert gas is argon.

In one embodiment the gaseous hydrocarbon is exposed to the solid catalyst prior to, during or both prior to and during exposure to the microwave radiation.

The gaseous hydrocarbon may be exposed to the catalyst by any suitable method. For instance, by continuously feeding the gaseous hydrocarbon over the catalyst, for instance by using a fixed or fluidized bed.

In the process of the invention, the gaseous hydrocarbon is exposed to microwave radiation in the presence of the catalyst in order to effect, or activate, the decomposition of said hydrocarbon to produce hydrogen. Said decomposition may be catalytic decomposition. Exposing the gaseous hydrocarbon and catalyst to the microwave radiation may cause them to heat up, but does not necessarily cause them to be heated. Other possible effects of the microwave radiation to which the gaseous hydrocarbon and catalyst are exposed (which may be electric or magnetic field effects) include, but are not limited to, field emission, plasma generation and work function modification. For instance, the high fields involved can modify catalyst work functions and can lead to the production of plasmas at the catalyst surface, further shifting the character of the chemical processes involved. Any one or more of such effects of the electromagnetic radiation may be responsible for, or at least contribute to, effecting, or activating, the catalytic decomposition of the gaseous hydrocarbon to produce hydrogen.

Optionally, the process may further comprise heating the composition conventionally, i.e. heating the composition by a means other than exposing it to electromagnetic radiation. The process may, for instance, further comprise heating the composition externally. That is, the process may additionally comprise applying heat to the outside of the vessel, reactor or reaction cavity which contains the composition. As mentioned above, the process, and in particular the step of exposing the composition to the electromagnetic radiation, is often carried out under ambient conditions. For instance, it may be carried out at SATP, i.e. at a temperature of about 298.15 K (25° C.) and at about 100,000 Pa (1 bar, 14.5 psi, 0.9869 atm).

In principle, microwave radiation having any frequency in the microwave range, i.e. any frequency of from 300 MHz to 300 GHz, may be employed in the present invention. Typically, however, microwave radiation having a frequency of from 900 MHz to 4 GHz, or for instance from 900 MHz to 3 GHz, is employed.

In one embodiment, the microwave radiation has a frequency of from about 1 GHz to about 4 GHz. Suitably, the microwave radiation has a frequency of about 2 GHz to about 4 GHz, suitably about 2 GHz to about 3 GHz, suitably about 2.45 GHz.

The power which the microwave radiation needs to delivered to the composition, in order to effect the decomposition of the hydrocarbon to produce hydrogen, will vary, according to, for instance, the particular hydrocarbons employed in the composition, the particular catalyst employed in the composition, and the size, permittivity, particle packing density, shape and morphology of the composition. The skilled person, however, is readily able to determine a level of power which is suitable for effecting the decomposition of a particular composition.

The process of the invention may for example comprise exposing the gaseous hydrocarbon to microwave radiation which delivers a power per cubic centimetre of at least 1 Watt. It may however comprise exposing the gaseous hydrocarbon to microwave radiation which delivers a power per cubic centimetre of at least 5 Watts.

Often, for instance, the process comprises exposing the gaseous hydrocarbon to microwave radiation which delivers a power of at least 10 Watts, or for instance at least 20 Watts, per cubic centimetre. The process of the invention may for instance comprise exposing the gaseous hydrocarbon to microwave radiation which delivers at least 25 Watts per cubic centimetre.

Often, for instance, the process comprises exposing the gaseous hydrocarbon to microwave radiation which delivers a power of from about 0.1 Watt to about 5000 Watts per cubic centimetre. More typically, the process comprises exposing the gaseous hydrocarbon to microwave radiation which delivers a power of from about 0.5 Watts to 30 about 1000 Watts per cubic centimetre, or for instance a power of from about 1 Watt to about 500 Watts per cubic centimetre, such as, for instance, a power of from about 1.5 Watts to about 200 Watts, or say, from 2 Watts to 100 Watts, per cubic centimetre.

In some embodiments, the process comprises exposing the gaseous hydrocarbon to microwave radiation which delivers from about 5 Watts to about 100 Watts per cubic centimetre, or for instance from about 10 Watts to about 100 Watts per cubic centimetre, or for instance from about 20 Watts, or from about 25 Watts, to about 80 Watts per cubic centimetre.

In some embodiments, for instance, the process comprises exposing the gaseous hydrocarbon to microwave radiation which delivers a power of from about 2.5 to about 60 Watts per cubic centimetre. Thus, for example, if the volume of the gaseous hydrocarbon is 3.5 cm³, the process of the invention typically comprises exposing the gaseous hydrocarbon to microwave radiation which delivers about 10 W to about 200 W (i.e. the “absorbed power” is from about 10 W to about 200 W).

Often, the power delivered to the gaseous hydrocarbon (or the “absorbed power”) is ramped up during the process of the invention. Thus, the process may comprise exposing the gaseous hydrocarbon to microwave radiation which delivers a first power to the composition, and then exposing the gaseous hydrocarbon to microwave radiation which delivers a second power to the gaseous hydrocarbon, wherein the second power is greater than the first. The first power may for instance be from about 2.5 Watts to about 6 Watts per cubic centimetre of the gaseous hydrocarbon. The second power may for instance be from about 25 Watts to about 60 Watts per cubic centimetre of the gaseous hydrocarbon.

The duration of exposure of the composition to the microwave radiation may also vary in the process of the invention. Embodiments are, for instance, envisaged wherein a given gaseous hydrocarbon is exposed to microwave radiation over a relatively long period of time, to effect sustained decomposition of the hydrocarbon on a continuous basis to produce hydrogen over a sustained period.

Electromagnetic heating provides a method of fast, selective heating of dielectric and magnetic materials. Rapid and efficient heating using microwaves is an example in which inhomogeneous field distributions in dielectric mixtures and field-focussing effects can lead to dramatically different product distributions. The fundamentally different mechanisms involved in electromagnetic heating may cause enhanced reactions and new reaction pathways. Furthermore, the high fields involved can modify catalyst work functions and can lead to the production of plasmas at the catalyst surface, further shifting the character of the chemical processes involved.

In one embodiment, the process of the invention comprises heating said gaseous hydrocarbon by exposing it to microwave radiation.

### Gaseous Hydrocarbon

The gaseous hydrocarbon is in the gaseous state at standard ambient temperature and pressure (SATP), i.e. at a temperature of 298.15 K (25° C.) and at 100,000 Pa (1 bar, 14.5 psi, 0.9869 atm). Said gaseous hydrocarbon will typically also be in the gaseous under the conditions (i.e. the temperature and pressure) at which the process is carried out.

In one embodiment, the composition comprises only one gaseous hydrocarbon. In another embodiment, the composition comprises a mixture of gaseous hydrocarbons.

In one embodiment, the gaseous hydrocarbon is substantially free of oxygenated species. In another embodiment, the gaseous hydrocarbon is free of oxygenated species.

In one embodiment, the gaseous hydrocarbon is substantially free of oxygen. In another embodiment, the gaseous hydrocarbon is free of oxygen.

In one embodiment, the gaseous hydrocarbon is substantially free of water. In another embodiment, the gaseous hydrocarbon is free of water.

In one embodiment, the gaseous hydrocarbon is substantially free of oxygenated species and water. In another embodiment, the gaseous hydrocarbon is free of oxygenated species and water.

In one embodiment, the composition is gaseous hydrocarbon free of oxygen, oxygenated species and water. In another embodiment, the gaseous hydrocarbon is free of oxygen, oxygenated species and water.

In one embodiment, gaseous hydrocarbon essentially consists of one or more C₁₋₄ hydrocarbons. In another embodiment, the gaseous hydrocarbon consists of one or more C₁₋₄ hydrocarbons. In another embodiment, the gaseous hydrocarbon consists of a single hydrocarbon selected from a C₁₋₄ hydrocarbons.

In another embodiment, the gaseous hydrocarbon is a single hydrocarbon selected from a C₁₋₄ hydrocarbon. Suitably, the gaseous hydrocarbon is selected from methane, ethane, propane, n-butane and iso-butane. Suitably, the gaseous hydrocarbon is selected from methane, ethane and propane. Suitably, the gaseous hydrocarbon is selected from methane and ethane. Suitably, the gaseous hydrocarbon is methane.

### Solid Catalyst

The solid catalyst employed in the process of the present invention comprises at least one iron species.

In one embodiment, the iron species is selected from elemental iron, iron oxides, iron salts, iron alloys, iron hydroxides and iron hydrides. Suitably, the iron species is selected from elemental iron, iron oxides, iron salts and iron alloys. In one embodiment, the iron species is a selected from elemental iron, an iron oxide and a mixture thereof.

In addition to comprising iron, the iron species may further comprise a further metal species, such as an elemental metal or metal oxide. Suitably the further metal species is a transition metal species.

In one embodiment the further metal species additionally comprises a transition metal selected from Sc, Y, Ti, Zr, Hf, V, Nb, Ta, Cr, Mo, W, Mn, Tc, Re, Ru, Os, Co, Rh, Ir, Ni, Pd, Pt, Cu, Ag, Au and Zn.

In another embodiment the further metal species additionally comprises a transition metal selected from Ti, V, Nb, Ta, Cr, Mo, W, Mn, Tc, Re, Ru, Os, Co, Rh, Ir, Ni, Pd, Pt, Cu, Ag, Au and Zn.

In another embodiment the further metal species additionally comprises a transition metal selected from V, Nb, Ta, Cr, Mo, W, Mn, Tc, Re, Ru, Os, Co, Rh, Ir, Ni, Pd, Pt, Cu, Ag, Au and Zn.

In another embodiment, the further metal species additionally comprises a transition metal selected from Ru, Os, Co, Rh, Ir, Ni, Mn, Pd, Pt and Cu.

In another embodiment, the further metal species is selected from the group consisting of Al, Mn, Ru, Co, Ni and Cu.

In one embodiment, the iron species comprises/essentially consists of/consists of a binary mixture of elemental metals selected from elemental Fe and elemental Ni (Fe/Ni), elemental Fe and elemental cobalt (Fe/Co), elemental Fe and elemental Ru (Fe/Ru), elemental Fe and elemental Cu (Fe/Cu), elemental Fe and elemental Al (Fe/AI), and elemental Fe and elemental Mn (Fe/Mn).

In another embodiment, the iron species comprises/essentially consists of/consists of a binary mixture of elemental Fe and a manganese oxide (Fe/MnOₓ) or a binary mixture of elemental Fe and an aluminium oxide (Fe/AlOₓ).

Typically, the catalyst comprises particles of said iron/metal species. The particles are usually nanoparticles.

Suitably, where said metal species comprises/essentially consists of/consists of metal(s) in elemental form said species is present as nanoparticles.

As used herein the term “nanoparticle” means a microscopic particle whose size is typically measured in nanometres (nm). A nanoparticle typically has a particle size of from 0.5 nm to 500 nm. For instance, a nanoparticle may have a particle size of from 0.5 nm to 200 nm. More often, a nanoparticle has a particle size of from 0.5 nm to 100 nm, or for instance from 1 nm to 50 nm. A particle, for instance a nanoparticle, may be spherical or non-spherical. Non-spherical particles may for instance be plate-shaped, needle-shaped or tubular.

The term “particle size” as used herein means the diameter of the particle if the particle is spherical or, if the particle is non-spherical, the volume-based particle size. The volume-based particle size is the diameter of the sphere that has the same volume as the nonspherical particle in question.

In one embodiment, the particle size of the iron/metal species may be in the nanoscale. For instance, the particle size diameter of the iron/metal species may be in the nanoscale.

As used herein, a particle size diameter in the nanoscale refers to populations of nanoparticles having d(0.5) values of 100 nm or less. For example, d(0.5) values of 90 nm or less. For example, d(0.5) values of 80 nm or less. For example, d(0.5) values of 70 nm or less. For example, d(0.5) values of 60 nm or less. For example, d(0.5) values of 50 nm or less. For example, d(0.5) values of 40 nm or less. For example, d(0.5) values of 30 nm or less. For example, d(0.5) values of 20 nm or less. For example, d(0.5) values of 10 nm or less.

As used herein, “d(0.5)” (which may also be written as “d(v, 0.5)” or volume median diameter) represents the particle size (diameter) for which the cumulative volume of all particles smaller than the d(0.5) value in a population is equal to 50% of the total volume of all particles within that population.

A particle size distribution as described herein (e.g. d(0.5)) can be determined by various conventional methods of analysis, such as Laser light scattering, laser diffraction, sedimentation methods, pulse methods, electrical zone sensing, sieve analysis and optical microscopy (usually combined with image analysis).

In one embodiment, a population of iron/metal species of the process have d(0.5) values of about 1 nm to about 100 nm. For example, d(0.5) values of about 1 nm to about 90 nm. For example, d(0.5) values of about 1 nm to about 80 nm. For example, d(0.5) values of about 1 nm to about 70 nm. For example, d(0.5) values of about 1 nm to about 60 nm. For example, d(0.5) values of about 1 nm to about 50 nm. For example, d(0.5) values of about 1 nm to about 40 nm. For example, d(0.5) values of about 1 nm to about 30 nm. For example, d(0.5) values of about 1 nm to about 20 nm. For example, d(0.5) values of about 1 nm to about 10 nm.

In another embodiment, a population of iron/metal species of the process have d(0.5) values of about 10 nm to about 100 nm. For example, d(0.5) values of about 10 nm to about 90 nm. For example, d(0.5) values of about 10 nm to about 80 nm. For example, d(0.5) values of about 10 nm to about 70 nm. For example, d(0.5) values of about 10 nm to about 60 nm. For example, d(0.5) values of about 10 nm to about 50 nm. For example, d(0.5) values of about 10 nm to about 40 nm. For example, d(0.5) values of about 10 nm to about 30 nm. For example, d(0.5) values of about 10 nm to about 20 nm. For example, d(0.5) values of about 10 nm.

In another embodiment, a population of iron/metal species of the process have have d(0.5) values of about 20 nm to about 100 nm. For example, d(0.5) values of about 20 nm to about 90 nm. For example, d(0.5) values of about 20 nm to about 80 nm. For example, d(0.5) values of about 20 nm to about 70 nm. For example, d(0.5) values of about 20 nm to about 60 nm. For example, d(0.5) values of about 20 nm to about 50 nm. For example, d(0.5) values of about 20 nm to about 40 nm. For example, d(0.5) values of about 20 nm to about 30 nm. For example, d(0.5) values of about 20 nm.

In another embodiment, a population of iron/metal species of the process have d(0.5) values of about 30 nm to about 100 nm. For example, d(0.5) values of about 30 nm to about 90 nm. For example, d(0.5) values of about 30 nm to about 80 nm. For example, d(0.5) values of about 30 nm to about 70 nm. For example, d(0.5) values of about 30 nm to about 60 nm. For example, d(0.5) values of about 30 nm to about 50 nm. For example, d(0.5) values of about 30 nm to about 40 nm. For example, d(0.5) values of about 30 nm.

In another embodiment, a population of iron/metal species of the process have d(0.5) values of about 20 nm to about 100 nm. For example, d(0.5) values of about 40 nm to about 90 nm. For example, d(0.5) values of about 40 nm to about 80 nm. For example, d(0.5) values of about 40 nm to about 70 nm. For example, d(0.5) values of about 40 nm to about 60 nm. For example, d(0.5) values of about 40 nm to about 50 nm. For example, d(0.5) values of about 40 nm.

In another embodiment, a population of iron/metal species of the process have d(0.5) values of about 50 nm to about 100 nm. For example, d(0.5) values of about 50 nm to about 90 nm. For example, d(0.5) values of about 50 nm to about 80 nm. For example, d(0.5) values of about 50 nm to about 70 nm. For example, d(0.5) values of about 50 nm to about 60 nm. For example, d(0.5) values of about 50 nm.

The iron species of the solid catalyst employed in the process of the present invention is supported on a support comprising a ceramic material or carbon. In one embodiment, support is a ceramic support. In another embodiment, the support is carbon.

Suitable supports typically have high thermal conductivity, mechanical strength and good dielectric properties.

In one embodiment, the ceramic material is a non-oxygenated ceramic such as a boride, carbide, nitride or silicide. Suitably, the ceramic material is a carbide.

In one embodiment, the ceramic material is selected from one or more of silicon carbide, boron carbide, tungsten carbide, zirconium carbide, aluminium carbide, aluminium nitride and silicon nitride.

In another embodiment, the ceramic material is selected from silicon carbide, boron carbide, tungsten carbide, zirconium carbide and aluminium carbide. Suitably, the ceramic material is selected from silicon carbide and silicon nitride. For instance, in one embodiment, the ceramic material is silicon carbide.

In another embodiment, the ceramic material is a metal or metalloid oxide.

Suitably, the ceramic material is a selected from oxides of aluminium, silicon, titanium and zirconium or mixtures thereof. In one embodiment, the ceramic material is selected from Al₂O₃, SiO₂, TiO₂ ZrO₂ and aluminium silicates.

In one embodiment, the ceramic material is selected from silicon carbide, boron carbide, tungsten carbide, zirconium carbide, aluminium carbide, Al₂O₃, SiO₂, TiO₂ ZrO₂ and aluminium silicates. In another embodiment, the ceramic material is selected from silicon carbide, Al₂O₃, SiO₂, TiO₂ ZrO₂ and aluminium silicates. In another embodiment, the ceramic material is selected from silicon carbide, Al₂O₃ and SiO₂.

In one embodiment, the support comprises a carbon. Suitably, the support is a carbon support. Suitable types of carbon include carbon allotropes, such as graphite, graphene and carbon nanoparticles (e.g. carbon nanotubes), activated carbon and carbon black.

In one embodiment, the support comprises activated carbon. In another embodiment the support is activated carbon.

In one embodiment, the support is in monolithic form.

The solid catalyst of the process of the invention, in one embodiment comprises/essentially consists of/consists of an iron species which is elemental iron, an iron oxide, iron alloy, or mixture thereof; and a ceramic material which is a non-oxygenated ceramic. Suitably, the non-oxygenated ceramic is selected from of silicon carbide, boron carbide, tungsten carbide, zirconium carbide, aluminium carbide, aluminium nitride and silicon nitride; more suitably silicon carbide.

In another embodiment, the solid catalyst of the process of the invention, in one embodiment comprises/essentially consists of/consists of an iron species which is elemental iron, an iron oxide, iron alloy, or mixture thereof; and a ceramic material which is a metal or metalloid oxide. Suitably, the metal or metalloid oxide is selected from an oxide of aluminium, silicon, titanium and zirconium or mixtures thereof.

In another embodiment, the solid catalyst of the process of the invention, in one embodiment comprises/essentially consists of/consists of an iron species which is elemental iron, an iron oxide, iron alloy, or mixture thereof; and a ceramic material is selected from silicon carbide, boron carbide, tungsten carbide, zirconium carbide, aluminium carbide, Al₂O₃, SiO₂, TiO₂ ZrO₂ and aluminium silicates.

In another embodiment, the solid catalyst of the process of the invention, comprises/essentially consists of/consists of an iron species which is elemental iron, an iron oxide, iron alloy, or mixture thereof; and a ceramic material is selected from silicon carbide, Al₂O₃ and SiO₂.

In one embodiment, the solid catalyst of the process of the invention, comprises/essentially consists of/consists of an iron species which is elemental iron or an iron oxide; and a ceramic material which is a non-oxygenated ceramic. Suitably, the non-oxygenated ceramic is selected from of silicon carbide, boron carbide, tungsten carbide, zirconium carbide, aluminium carbide, aluminium nitride and silicon nitride; more suitably silicon carbide.

In one embodiment, the solid catalyst of the process of the invention, comprises/essentially consists of/consists of an iron species which is elemental iron or an iron oxide; and a ceramic material which is a metal or metalloid oxide. Suitably, the metal or metalloid oxide is selected from an oxide of aluminium, silicon, titanium and zirconium or mixtures thereof.

In one embodiment, the solid catalyst of the process of the invention, comprises/essentially consists of/consists of an iron species which is elemental iron or an iron oxide; and a ceramic material selected from silicon carbide, boron carbide, tungsten carbide, zirconium carbide, aluminium carbide, Al₂O₃, SiO₂, TiO₂ ZrO₂ and aluminium silicates.

In one embodiment, the solid catalyst of the process of the invention, comprises/essentially consists of/consists of an iron species which is elemental iron or an iron oxide; and a ceramic material selected from silicon carbide, Al₂O₃ and SiO₂.

In one embodiment, the solid catalyst of the process of the invention comprises/essentially consists of/consists of an iron species which is elemental iron; and a ceramic material which is a non-oxygenated ceramic. Suitably, the non-oxygenated ceramic is selected from of silicon carbide, boron carbide, tungsten carbide, zirconium carbide, aluminium carbide, aluminium nitride and silicon nitride; more suitably silicon carbide.

In one embodiment, the solid catalyst of the process of the invention, comprises/essentially consists of/consists of an iron species which is elemental iron; and a ceramic material which is a metal or metalloid oxide. Suitably, the metal or metalloid oxide is selected from an oxide of aluminium, silicon, titanium and zirconium or mixtures thereof.

In one embodiment, the solid catalyst of the process of the invention, comprises/essentially consists of/consists of an iron species which is elemental iron; and a ceramic material selected from silicon carbide, boron carbide, tungsten carbide, zirconium carbide, aluminium carbide, Al₂O₃, SiO₂, TiO₂ ZrO₂ and aluminium silicates.

In one embodiment, the solid catalyst of the process of the invention, comprises/essentially consists of/consists of a iron species which is elemental iron; and a ceramic material selected from silicon carbide, Al₂O₃ and SiO₂.

In one embodiment, the solid catalyst comprises/essentially consists of/consists of elemental Fe supported on a silicon carbide support. Suitably, the elemental Fe is present in about 1 to about 25 wt. % of the catalyst, suitably about 1 to about 20 wt. % of the catalyst, suitably about 1 to about 10 wt. % of the catalyst, suitably about 1 to about 5 wt. % of the catalyst, more suitably about 5 wt. %.

In one embodiment, the solid catalyst comprises/essentially consists of/consists of elemental Fe supported on a SiO₂ support. Suitably, the elemental Fe is present in about 1 to about 60 wt. % of the catalyst, suitably about 1 to about 50 wt. % of the catalyst, suitably about 1 to about 40 wt. % of the catalyst, suitably about 1 to about 30 wt. % of the catalyst, suitably about 1 to about 20 wt. % of the catalyst, suitably about 1 to about 10 wt. % of the catalyst, suitably about 1 to about 5 wt. % of the catalyst, more suitably about 5 wt. %.

In one embodiment, the solid catalyst comprises/essentially consists of/consists of elemental Fe supported on an Al₂O₃ support. Suitably, the elemental Fe is present in about 1 to about 60 wt. % of the catalyst, suitably about 1 to about 50 wt. % of the catalyst, suitably about 1 to about 40 wt. % of the catalyst, suitably about 1 to about 30 wt. % of the catalyst, suitably about 1 to about 20 wt. % of the catalyst, suitably about 1 to about 10 wt. % of the catalyst, suitably about 1 to about 5 wt. % of the catalyst, more suitably about 5 wt. %.

In one embodiment, the solid catalyst comprises/essentially consists of/consists of elemental Fe supported on an activated carbon support. Suitably, the elemental Fe is present in about 1 to about 60 wt. % of the catalyst, suitably about 1 to about 50 wt. % of the catalyst, suitably about 1 to about 40 wt. % of the catalyst, suitably about 1 to about 30 wt. of the catalyst, suitably about 1 to about 20 wt. % of the catalyst, suitably about 1 to about 10 wt. % of the catalyst, suitably about 1 to about 5 wt. % of the catalyst, more suitably about 5 wt. %.

Typically, in the solid catalyst, the iron species is present in an amount of from 0.1 to 99 weight %, based on the total weight of the catalyst. It may for instance be present in an amount of from 0.5 to 80 weight %, based on the total weight of the catalyst. It may however be present in an amount of from 0.5 to 25 weight %, more typically from 0.5 to 40 weight % or, for instance from 1 to 30 weight %, based on the total weight of the catalyst.

The iron species may for instance be present in an amount of from 0.1 to 90 weight %, for instance from 0.1 to 10 weight %, or, for instance from 20 to 70 weight %, based on the total weight of the catalyst.

The iron species may for instance be present in an amount of from 1 to 20 weight %, for instance from 1 to 15 weight %, or, for example from 2 to 110 weight %, based on the total weight of the catalyst.

In one embodiment, the solid catalyst has an iron species loading of up to about 50 wt. %.

In another embodiment, the solid catalyst has an iron species loading of from about 0.1 wt. % to about 50 wt. %, for instance from about 1 wt. % to about 20 wt. %; for instance, about from about 1 wt. % to about 15 wt. %; for instance from about 1 wt. % to about 10 wt. %; for instance, from about 2 wt. % to about 5 wt. %.

In another embodiment, the solid catalyst has an iron species loading of about 5 wt. %.

### Heterogeneous Mixture

In another aspect, the present invention provides comprising a solid catalyst in intimate mixture with a gaseous hydrocarbon wherein the catalyst comprises at least one iron species supported on a support comprising a ceramic material or carbon, or mixture thereof.

With respect to the solid catalyst, composition and the features thereof, each of the above described embodiments are equally applicable to this aspect of the invention.

The present invention further relates to the use of the above described heterogeneous mixture to produce hydrogen.

This can be achieved by exposing the heterogeneous mixture to microwave radiation as described above.

### Microwave Reactor

In another aspect, the present invention relates to a microwave reactor comprising a heterogeneous mixture, said mixture comprising a solid catalyst in intimate mixture with a gaseous hydrocarbon, wherein the catalyst comprises at least one iron species supported on a support comprising a ceramic or carbon material, or mixture thereof.

With respect to the solid catalyst, gaseous hydrocarbon and the features thereof, each of the above described embodiments are equally applicable to this aspect of the invention.

Typically, the reactor is configured to receive the gaseous hydrocarbon and catalyst to be exposed to radiation. The reactor typically therefore comprises at least one vessel or inlet configured to comprise and/or convey the gaseous hydrocarbon in/to a reaction cavity, said cavity being the focus of the microwave radiation.

The reactor is also configured to export hydrogen. Thus, the reactor typically comprises an outlet through which hydrogen gas, generated in accordance with the process of the invention, may be released or collected.

In some embodiments, the microwave reactor is configured to subject the composition to electric fields in the TM010 mode.

### Fuel Cell Module

In a another aspect, the present invention provides a fuel cell module comprising a (i) a fuel cell and (ii) a heterogeneous mixture comprising a solid catalyst in intimate mixture with a gaseous hydrocarbon wherein the catalyst comprises at least one iron species supported on a support comprising a ceramic or carbon material, or mixture thereof.

Fuel cells, such as proton exchange membrane fuel cells, are well known in the art and thus readily available to the skilled person.

In one embodiment, the fuel cell module may further comprise (iii) a source of microwave radiation. Suitably, the source of microwave radiation is suitable for exposing the gaseous hydrocarbon and catalyst to microwave radiation and thereby effecting decomposition of the gaseous hydrocarbon or a component thereof to produce hydrogen. Said decomposition may be catalytic decomposition.

Suitably, the source of the microwave radiation is a microwave reactor, suitably as described above.

The invention is further described by means of the following numbered paragraphs:

1. A process for producing a gaseous product comprising hydrogen, said process comprising exposing a gaseous hydrocarbon to microwave radiation in the presence of a solid catalyst, wherein the catalyst comprises at least one iron species supported on a support comprising a ceramic material or carbon, or a mixture thereof.
2. A process according to paragraph 1 wherein the gaseous product produced comprises about 90% vol. or more of hydrogen, suitably about 95% vol. or more of hydrogen.
3. A process according to paragraph 1 wherein the gaseous product produced comprises from about 90% vol. to about 100% vol. of hydrogen.
4. A process according to any preceding paragraph wherein the gaseous product produced comprises less than about 1% vol. of carbon dioxide, suitably less than about 0.5% vol. of carbon dioxide.
5. A process according to any preceding paragraph wherein the iron species is selected from the group consisting of elemental iron, an iron alloy, iron salts, iron hydrides, an iron oxide, an iron carbide and an iron hydroxide, or a mixture thereof.
6. A process according to paragraph 5 wherein the iron species is selected from the group consisting of elemental iron, an iron alloy, an iron oxide, an iron carbide and an iron hydroxide, or a mixture thereof.
7. A process according to paragraph 5 wherein the iron species is selected from the group consisting of elemental iron, an iron alloy, an iron oxide, and an iron hydroxide, or a mixture thereof.
8. A process according to paragraph 5 wherein the iron species is selected from the group consisting of elemental Fe, an iron oxide, and a mixture thereof.
9. A process according to any preceding paragraph wherein the at least one iron species consists of a mixture of elemental metals or a mixture of metal oxides.
10. A process according to any preceding paragraphs wherein the catalyst comprises a further metal species, suitably a further transition metal.
11. A process according to paragraph 10 wherein the transition metal is selected from one or more of Ti, V, Nb, Ta, Cr, Mo, W, Mn, Tc, Re, Fe, Ru, Os, Co, Rh, Ir, Ni, Pd, Pt, Cu, Ag, Au and Zn.
12. A process according to claim 10 wherein the further metal species is selected from the group consisting of Al, Mn, Ru, Co, Ni and Cu.
13. A process according to paragraph 10 wherein the iron species consists of binary mixture of elemental Fe and elemental Ni (Fe/Ni), elemental Fe and elemental cobalt (Fe/Co), elemental Fe and elemental Ru (Fe/Ru); and elemental Fe and elemental Cu (Fe/Cu), elemental Fe and elemental Mn (Fe/Mn), elemental Fe and elemental Al (Fe/AI), elemental Fe and Mn oxide (Fe/MnOₓ).
14. A process according to any one of paragraphs 10 to 13 wherein the further metal species is in elemental form, or an oxide thereof.
15. A process according to any preceding paragraph wherein the iron species is present as nanoparticles.
16. A process according to any one of the preceding paragraphs wherein the support comprises a ceramic material.
17. A process according to paragraph 16 wherein the ceramic material is a non-oxygenated ceramic, such as a boride, carbide, nitride or silicide.
18. A process according to paragraph 16 wherein the ceramic material is selected from the group consisting of silicon carbide, boron carbide, tungsten carbide, zirconium carbide, aluminium carbide, aluminium nitride and silicon nitride.
19. A process according to paragraph 16 wherein the ceramic material is a metal or metalloid oxide.
20. A process according to paragraph 19 wherein the ceramic material is selected from the group consisting of oxides of aluminium, silicon, titanium or zirconium, and mixtures thereof.
21. A process according to paragraph 19 wherein the ceramic material is selected from the group consisting of Al₂O₃, SiO₂, TiO₂ ZrO₂ and aluminium silicates.
22. A process according to paragraph 16 wherein the ceramic material is selected from the group consisting of silicon carbide, Al₂O₃, SiO₂, TiO₂ ZrO₂ and aluminium silicates.
23. A process according to paragraph 16 wherein the ceramic material is selected from the group consisting of silicon carbide, Al₂O₃ and SiO₂.
24. A process according to paragraph 16 wherein the ceramic material is selected from an aluminium oxide, a silicon oxide and a silicon carbide.
25. A process according to any one of the preceding paragraphs wherein the support comprises carbon.
26. A process according to paragraph 25 wherein the carbon is selected from activated carbon, graphene, graphite, carbon black and carbon nanoparticles (e.g. carbon nanotubes).
27. A process according to paragraph 25 wherein the carbon is activated carbon.
28. A process according to any one of paragraphs 1 to 4 wherein solid catalyst comprises an iron species which is selected from the group consisting of elemental iron, an iron oxide, iron alloy, or mixture thereof; and a ceramic material which is a non-oxygenated ceramic.
29. A process according to paragraph 28 wherein the non-oxygenated ceramic is selected from of silicon carbide, boron carbide, tungsten carbide, zirconium carbide, aluminium carbide, aluminium nitride and silicon nitride.
30. A process according to paragraph 28 wherein the non-oxygenated ceramic is silicon carbide.
31. A process according to any one of paragraphs 1 to 4 wherein solid catalyst comprises an iron species which is selected from the group consisting of elemental iron, an iron oxide, iron alloy, or mixture thereof; and a ceramic material which is a metal or metalloid oxide.
32. A process according to paragraph 31 wherein the metal or metalloid oxide is selected from the group consisting of an oxide of aluminium, silicon, titanium or zirconium, and mixtures thereof.
33. A process according to paragraph 31 wherein the metal or metalloid oxide is an oxide of aluminium or silicon, and mixtures thereof.
34. A process according to any one of paragraphs 1 to 4 wherein solid catalyst comprises an iron species which is selected from the group consisting of elemental iron, an iron oxide, iron alloy, or mixture thereof; and a ceramic material which is selected from the group consisting of silicon carbide, Al₂O₃ and SiO₂.
35. A process according to paragraph 34 wherein the iron species is elemental iron or an iron oxide.
36. A process according to any one of paragraphs 1 to 4 wherein the solid catalyst comprises elemental iron supported on a ceramic material selected from the group consisting of silicon carbide, boron carbide, tungsten carbide, zirconium carbide, aluminium carbide, Al₂O₃, SiO₂, TiO₂ ZrO₂ and aluminium silicates.
37. A process according to paragraph 36 wherein the ceramic material is selected from the group consisting of silicon carbide, Al₂O₃, SiO₂, and aluminium silicates.
38. A process according to any one of paragraphs 1 to 4 wherein the solid catalyst comprises or consists of elemental Fe supported on a silicon carbide support (Fe/SiC).
39. A process according to paragraph 38 wherein the elemental Fe is present in about 1 to about 25 wt. % of the catalyst, suitably about 1 to about 10 wt. % of the catalyst, suitably about 1 to about 5 wt. % of the catalyst, more suitably about 5 wt. %.
40. A process according to any one of paragraphs 1 to 4 wherein the solid catalyst comprises or consists of elemental Fe supported on a SiO₂ support (Fe/SiO₂).
41. A process according to paragraph 40 wherein the elemental Fe is the elemental Fe is present in about 1 to about 60 wt. % of the catalyst, suitably about 1 to about 10 wt. % of the catalyst, suitably about 1 to about 5 wt. % of the catalyst, more suitably about 5 wt. %.
42. A process according to any one of paragraphs 1 to 4 wherein the solid catalyst comprises or consists of elemental Fe supported on a Al₂O₃ support (Fe/Al₂O₃).
43. A process according to paragraph 41 wherein the elemental Fe is the elemental Fe is present in about 1 to about 60 wt. % of the catalyst, suitably about 1 to about 10 wt. % of the catalyst, suitably about 1 to about 5 wt. % of the catalyst, more suitably about 5 wt. %.
44. A process according to any preceding paragraphs wherein the catalyst further comprises carbon.
45. A process according to paragraph 44 wherein the carbon is selected from activated carbon, graphene, graphite, carbon black and carbon nanoparticles (e.g. carbon nantotubes).
46. A process according to any one of paragraphs 1 to 4 wherein the catalyst has an iron loading of up to about 50 wt. %.
47. A process according to paragraph 46 wherein the iron loading is from about 2 wt. % to about 10 wt. %, preferably about 5 wt. %.
48. A process according to any one of the preceding paragraphs wherein the gaseous hydrocarbon is selected from one or more C₁₋₄ hydrocarbons.
49. A process according to any one of the preceding paragraphs wherein the gaseous hydrocarbon is selected from one of methane, ethane, propane and butane.
50. A process according to any one of the preceding paragraphs wherein the gaseous hydrocarbon comprises methane.
51. A process according to paragraph 50 wherein the gaseous hydrocarbon comprises at least about 90 wt. % of methane.
52. A process according to paragraph 58 wherein the gaseous hydrocarbon comprises at least about 98 wt. % of methane.
53. A process according to any one of the preceding paragraphs wherein the microwave radiation is of a frequency of from about 1.0 GHz to about 4.0 GHz, suitably about 2.0 GHz to about 4.0 GHz.
54. A process according to any one of the preceding paragraphs wherein the process is conducted in the absence of oxygen.
55. A process according to any one of the preceding paragraphs wherein the process is conducted in the absence of water.

### EXAMPLES

### Materials and Methods

I. Preparation of the catalysts

The catalysts were prepared using an incipient wetness impregnation method.

For instance, Fe(NO₃)₃·9H₂O (iron(III) nitrate nonahydrate, Sigma-Aldrich), was used as to provide the iron species whilst SiC (silicon carbide, Fisher Scientific) and AC (activated carbon, Sigma-Aldrich) were used as supports. The supports were mixed with the iron nitrate to produce a desired Fe loading. The mixture was then stirred at 150° C. on a magnetic hot plate for 3 hours until it became a slurry, and then dried overnight. The resulting solids were calcined in a furnace at 350° C. for 3 hours. Finally, the active catalysts were obtained by a reduction process in 10% H₂/Ar gases at 650° C. for 6 hours.

The same method was used to prepare other catalysts with different supporting materials. For the preparation of binary metal catalysts, the metal precursors were first mixed in distilled water and then blended with support powders.

The FeAlOₓ—C catalysts were prepared via a citric acid combustion method. Iron nitrate, aluminum nitrate and citric acid were mixed in a desirable ratio. Distilled water was then added in order to produce a viscous gel. The gel was then ignited and calcined in air at 350° C. for 3 hours. Finally, a loose powder was produced and then were ground into fine particles. For example, the Fe—Al₂O₃—C sample was prepared by mixing the iron nitrate, aluminium nitrate and citric acid by molar ratio of 1:1:1.

### II. Characterisation of Catalysts

The catalysts were characterised by powder X-ray diffraction (XRD) using a Cu Kα X-ray source (45 kV, 40 mA) on BRUKER D8 ADVANCE diffractometer. The scanning range (in 2θ) in this study was 10° to 90°.

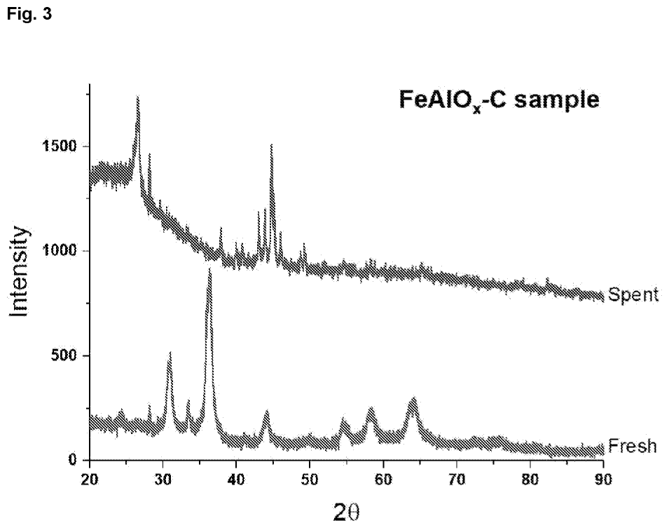

FIG. 3 illustrates the XRD pattern of Fe—Al₂O₃—C catalyst before and after microwave irradiation in the presence of methane. In FIG. 3 the characteristic peaks of iron oxides are observed in the fresh catalyst (20=31.3°, 34.6°, 36.3°, 44.2°, 54.9°, 58.1° and) 64.6°. In the pattern of spent catalyst, the characteristic peaks of iron carbide at the diffractions peaks of 2θ=42.9°, 43.9°, 44.8° and 46.0° are detected. In addition, a diffraction peak at about 2θ=26°, indicating the formation of multi-walled carbon nanotubes (MWCNTs).

The surface morphology of the prepared catalysts was characterised by Scanning Electron Microscope (SEM, Zeiss Evo).

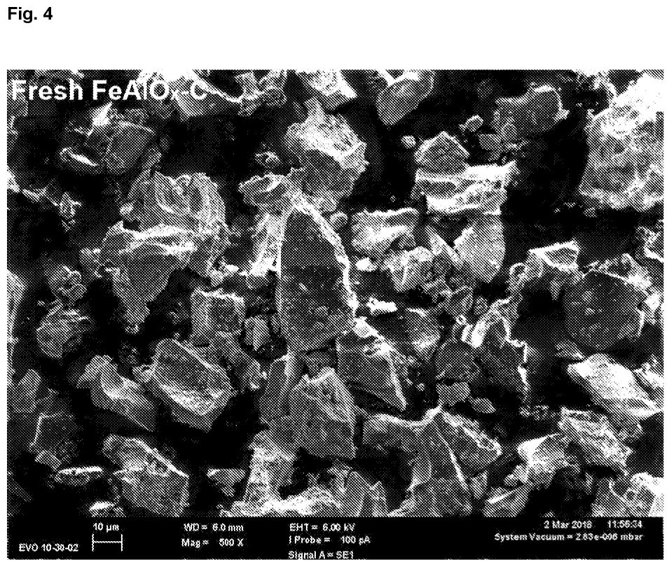

The morphology of prepared catalysts was characterised on Scanning Electron Microscope (SEM). FIG. 4 shows a SEM images of fresh Fe—Al₂O₃—C catalyst.

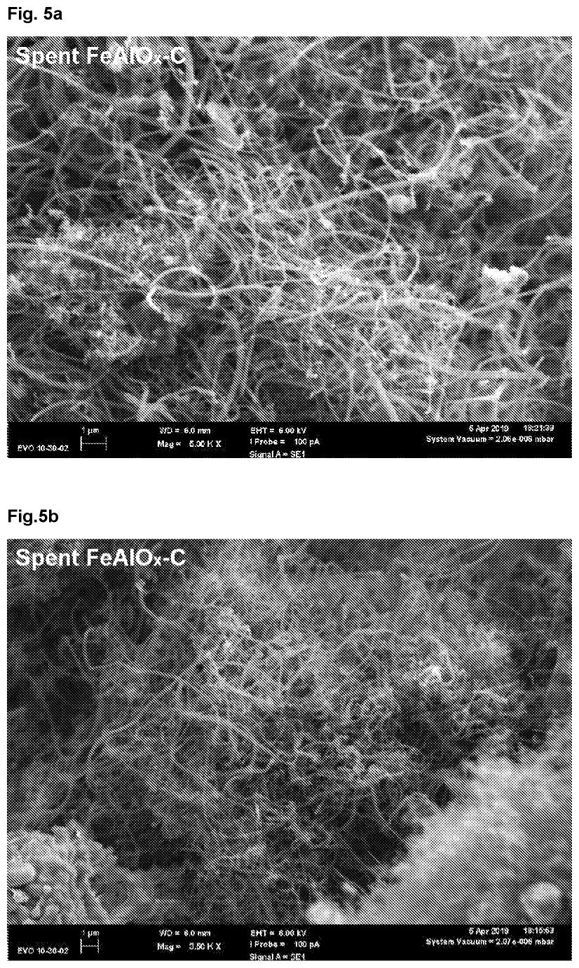

SEM images of spent Fe—Al₂O₃—C catalyst are given in FIGS. 5a and 5b.

### Dehydrogenation of Gaseous Hydrocarbons Under Microwave Radiation

The catalyst was first placed in a quartz tube (inner diameter 6 mm, outer diameter 9 mm), the height of the catalyst bed exposed to the axially polarised (TM₀₁₀) uniform electric fields is 4 cm. Then, the filled tube was placed axially in the centre of the TM₀₁₀ microwave cavity in order to minimise depolarisation effects under microwave radiation. Before starting microwave irradiation, the samples were purged with argon for about 15 min at a flow rate of about 1.67 mLs⁻¹. Then, the sample was irradiated with microwaves at 750 W for 120 to 240 minutes while exposing to methane at a rate of 20 ml/min. The generated gases were collected and analysed by Gas Chromatography (GC) using a Perkin-Elmer, Clarus 580 GC.

### Investigation of Catalyst Performance on Hydrogen Production

The methane dehydrogenation was measured against the theoretical complete decomposition reaction (1), with the conversion of methane therefore taken as (2). The selectivity described here is determined by GC as the Vol % in the effluent gases (3).

$${CH}_{4} \to C + 2 {H}_{2} \qquad ( 1 )$$

$$Conversion {CH}_{4} \% = \frac{{Vol H}_{2} / 2}{{Vol H}_{2} / 2 + Vol {CH}_{4}} \qquad ( 2 )$$

$${H}_{2} Selectivity ( Vol . \% ) = \frac{{Vol H}_{2}}{\sum Vol of all the products} \times 100 \% \qquad ( 3 )$$

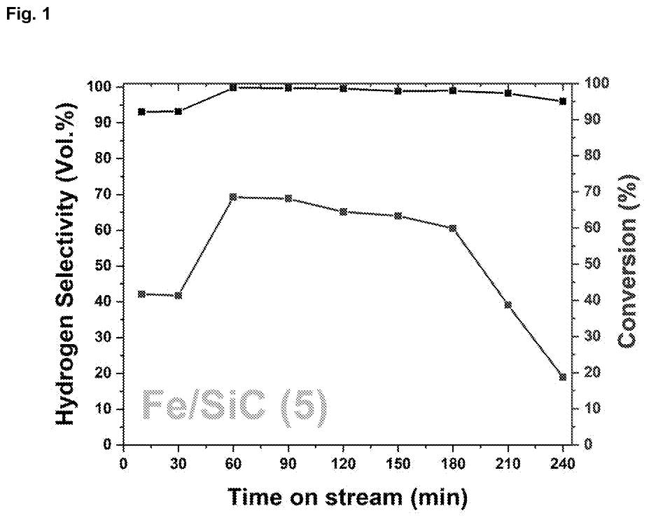

Several catalysts have been tested for hydrogen production through microwave-initiated catalytic methane decomposition. Fe catalysts supported by SiC catalysts presented excellent activity for methane dehydrogenation under microwave irradiation. In general, a hydrogen selectivity of >99% was obtained with the methane conversion reached ca. 70% over 5 wt. % Fe/SiC catalysts. The methane conversion started to decrease after 180 min of test and gradually decreased to ca. 2θ% after 240 min (FIG. 1).

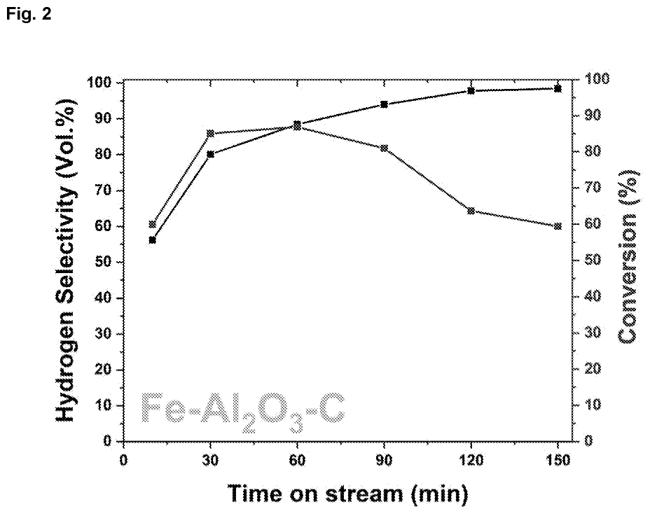

In addition, Fe—Al₂O₃—C catalysts also showed excellent catalytic activity towards methane dehydrogenation under microwave irradiation. Unlike Fe/SiC catalysts which were reduced under H₂/Ar gas before the test, the Fe—Al₂O₃—C catalysts were used as their oxidation states. Therefore, the hydrogen selectivity was low at the beginning of the test because CO was produced, and the hydrogen selectivity gradually increased to >95% after 90 min (FIG. 2).

Details of hydrogen selectivity and conversion of methane dehydrogenation experiments performed with other catalysts are given in Table 1.

TABLE 1
Product selectivity (Vol. %) and conversion (%) of
methane dehydrogenation under microwave irradiation.
750 W of microwave power is used for the methane
activation and the gas flow is set for 20 ml/min.

| | Product Selectivity (vol. %) | | | | | Conversion |
|---|---|---|---|---|---|---|
| Time | H₂ | CO₂ | CO | C₂H₆ | C₂H₄ | (%) |

Fe/SiC (10)

| | | | | | | |
|---|---|---|---|---|---|---|
| 10 min | 90.12 | 1.0 | 8.8 | 0.03 | 0.02 | 42.23 |
| 30 min | 91.06 | 0.8 | 8.1 | 0.02 | 0.02 | 36.97 |
| 60 min | 96.91 | 0.3 | 2.8 | 0.01 | 0.00 | 41.52 |
| 90 min | 92.98 | 0.6 | 6.3 | 0.06 | 0.02 | 20.58 |

FeMnOx/SiC (5, 2)

| | | | | | | |
|---|---|---|---|---|---|---|
| 10 min | 72.45 | 3.3 | 24.3 | 0.00 | 0.00 | 72.53 |
| 30 min | 97.42 | 0.5 | 2.0 | 0.03 | 0.01 | 32.55 |
| 90 min | 94.30 | 1.7 | 3.9 | 0.13 | 0.00 | 10.04 |
| 120 min | 90.50 | 3.7 | 5.6 | 0.27 | 0.00 | 4.07 |
| 150 min | 89.58 | 2.3 | 7.7 | 0.37 | 0.00 | 3.78 |
| 180 min | 86.50 | 3.4 | 9.7 | 0.45 | 0.00 | 3.39 |

Ni/SiC (5)

| | | | | | | |
|---|---|---|---|---|---|---|
| 10 min | 88.76 | 0.2 | 11.0 | 0.07 | 0.00 | 18.27 |
| 30 min | 92.32 | 0.6 | 5.2 | 0.64 | 1.30 | 12.18 |
| 60 min | 83.51 | 1.0 | 12.2 | 1.71 | 1.55 | 4.46 |
| 90 min | 81.23 | 1.4 | 14.6 | 1.78 | 0.99 | 3.26 |
| 120 min | 79.72 | 0.2 | 18.0 | 1.50 | 0.57 | 2.90 |

Fe₂O₃/SiC (20)

| | | | | | | |
|---|---|---|---|---|---|---|
| 10 min | 64.99 | 13.8 | 21.2 | 0.02 | 0.01 | 45.03 |
| 30 min | 91.34 | 0.3 | 8.3 | 0.02 | 0.01 | 45.95 |
| 60 min | 92.49 | 1.2 | 6.1 | 0.14 | 0.01 | 16.11 |
| 90 min | 92.85 | 0.5 | 6.4 | 0.21 | 0.02 | 10.96 |
| 120 min | 91.56 | 1.2 | 6.9 | 0.29 | 0.02 | 7.69 |
| 150 min | 93.11 | 0.8 | 5.3 | 0.79 | 0.02 | 8.28 |

Fe/SiO₂ (50)

| | | | | | | |
|---|---|---|---|---|---|---|
| 5 min | 70.04 | 0.0 | 29.9 | 0.04 | 0.03 | 22.00 |
| 30 min | 85.13 | 0.2 | 14.6 | 0.03 | 0.01 | 42.42 |
| 60 min | 87.90 | 0.4 | 11.5 | 0.17 | 0.02 | 11.80 |
| 90 min | 88.81 | 0.2 | 10.8 | 0.13 | 0.06 | 21.88 |
| 120 min | 87.01 | 0.1 | 12.4 | 0.45 | 0.05 | 5.81 |
| 150 min | 87.19 | 0.4 | 11.9 | 0.45 | 0.04 | 5.92 |
| 180 min | 85.34 | 0.9 | 13.3 | 0.42 | 0.02 | 5.26 |

Fe/SiO₂ (20)

| | | | | | | |
|---|---|---|---|---|---|---|
| 10 min | 78.67 | 4.6 | 16.7 | 0.02 | 0.00 | 48.79 |
| 30 min | 88.08 | 0.1 | 11.8 | 0.03 | 0.00 | 41.53 |
| 60 min | 93.09 | 0.2 | 6.7 | 0.04 | 0.00 | 34.96 |
| 90 min | 94.72 | 0.1 | 5.2 | 0.04 | 0.00 | 26.49 |
| 120 min | 93.62 | 0.2 | 6.1 | 0.05 | 0.00 | 26.66 |
| 150 min | 95.23 | 0.0 | 4.7 | 0.03 | 0.00 | 27.48 |
| 180 min | 95.57 | 0.0 | 4.4 | 0.02 | 0.00 | 28.07 |
| 210 min | 95.42 | 0.1 | 4.4 | 0.03 | 0.00 | 26.64 |
| 240 min | 96.27 | 0.0 | 3.7 | 0.04 | 0.00 | 26.48 |
| 270 min | 95.97 | 0.2 | 3.8 | 0.03 | 0.00 | 25.33 |
| 300 min | 95.64 | 0.3 | 4.0 | 0.05 | 0.00 | 23.74 |

Fe/SiC (5)

| | | | | | | |
|---|---|---|---|---|---|---|
| 10 min | 92.66 | 0.7 | 6.6 | 0.02 | 0.00 | 50.54 |
| 30 min | 99.13 | 0.1 | 0.7 | 0.02 | 0.00 | 58.78 |
| 60 min | 98.60 | 0.2 | 1.2 | 0.03 | 0.00 | 46.09 |
| 90 min | 98.34 | 0.2 | 1.4 | 0.03 | 0.00 | 43.00 |
| 120 min | 97.86 | 0.2 | 1.9 | 0.06 | 0.01 | 25.63 |
| 150 min | 95.68 | 0.5 | 3.7 | 0.09 | 0.00 | 14.79 |
| 180 min | 93.51 | 0.6 | 5.7 | 0.14 | 0.01 | 9.41 |
| 210 min | 93.64 | 0.9 | 5.4 | 0.12 | 0.00 | 9.51 |

Fe/SiC (5)

| | | | | | | |
|---|---|---|---|---|---|---|
| 10 min | 93.12 | 0.8 | 6.0 | 0.02 | 0.00 | 41.68 |
| 30 min | 93.18 | 0.9 | 5.9 | 0.02 | 0.00 | 41.30 |
| 60 min | 99.78 | 0.1 | 0.1 | 0.01 | 0.00 | 68.52 |
| 90 min | 99.75 | 0.1 | 0.1 | 0.00 | 0.00 | 68.13 |
| 120 min | 99.54 | 0.2 | 0.2 | 0.01 | 0.00 | 64.46 |
| 150 min | 98.85 | 0.4 | 0.7 | 0.02 | 0.00 | 63.33 |
| 180 min | 98.96 | 0.2 | 0.9 | 0.01 | 0.00 | 59.87 |
| 210 min | 98.26 | 0.2 | 1.5 | 0.04 | 0.01 | 38.67 |
| 240 min | 96.00 | 0.2 | 3.6 | 0.11 | 0.01 | 18.77 |

Fe—Al₂O₃—C

| | | | | | | |
|---|---|---|---|---|---|---|
| 10 min | 56.16 | 9.2 | 34.4 | 0.02 | 0.12 | 59.95 |
| 30 min | 80.07 | 0.6 | 19.1 | 0.01 | 0.09 | 85.07 |
| 60 min | 88.45 | 0.5 | 10.9 | 0.01 | 0.08 | 86.84 |
| 90 min | 94.01 | 0.7 | 5.1 | 0.01 | 0.08 | 80.97 |
| 120 min | 97.84 | 0.3 | 1.8 | 0.01 | 0.06 | 63.65 |
| 150 min | 98.44 | 0.3 | 1.2 | 0.02 | 0.06 | 59.39 |

### CONCLUSION

The described invention provides a new process which combines the microwave-assisted processing of gaseous hydrocarbons over solid catalysts for hydrogen production. Excellent hydrogen selectivity of >99% was obtainable and methane conversions of up to about 70% was achievable.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise paragraphed. No language in the specification should be construed as indicating any non-paragraphed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the paragraphs appended hereto as permitted by applicable law.

### REFERENCES

1. P. P. Edwards, V. L. Kuznetsov, W. I. F. David, N. P. Brandon, Hydrogen and fuel cells: Towards a sustainable energy future. Energy Policy 36, 4356-4362 (2008).
2. D. P. Gregory, D. Y. C. Ng, G. M. Long, The hydrogen economy. Electrochem. Cleaner Environ., 226-280 (1972).
3. J. A. Turner, Sustainable Hydrogen Production. Science (Washington, DC, U. S.) 305, 972-974 (2004).
4. M. Ni, M. K. H. Leung, D. Y. C. Leung, K. Sumathy, A review and recent developments in photocatalytic water-splitting using for hydrogen production. Renewable and Sustainable Energy Reviews 11, 401-425 (2007).
5. J. Turner et al., Renewable hydrogen production. Int. J. Energy Res. 32, 379-407 (2008).
6. L. Schlapbach, A. Zuettel, Hydrogen-storage materials for mobile applications. Nature (London, U. K.) 414, 353-358 (2001).
7. M. L. Wald, Questions about a hydrogen economy. Sci. Am. 290, 66-73 (2004).
8. B. Sakintuna, F. Lamari-Darkrim, M. Hirscher, Metal hydride materials for solid hydrogen storage: A review. International Journal of Hydrogen Energy 32, 1121-1140 (2007).
9. Z. Xiong et al., High-capacity hydrogen storage in lithium and sodium amidoboranes. Nat Mater 7, 138-141 (2008).
10. W. Grochala, P. P. Edwards, Thermal Decomposition of the Non-Interstitial Hydrides for the Storage and Production of Hydrogen. Chem. Rev. (Washington, DC, U. S.) 104, 1283-1315 (2004).
11. F. A. Armstrong, J. C. Fontecilla-Camps, A Natural Choice for Activating Hydrogen. Science (Washington, DC, U.S.) 322, 529 (2008).
12. A. Boddien et al., Efficient Dehydrogenation of Formic Acid Using an Iron Catalyst. Science (Washington, DC, U. S.) 333, 1733-1736 (2011).
13. M. Wang, L. Sun, Hydrogen Production by Noble-Metal-Free Molecular Catalysts and Related Nanomaterials. ChemSusChem 3, 551-554 (2010).
14. R. M. Navarro, M. A. Pena, J. L. G. Fierro, Hydrogen Production Reactions from Carbon Feedstocks: Fossil Fuels and Biomass. Chem. Rev. (Washington, DC, U. S.) 107, 3952-3991 (2007).
15. R. J. Pearson et al., Energy storage via carbon-neutral fuels made from CO₂, water, and renewable energy. Proc. IEEE 100, 440-460 (2012).
16. Gonzalez-Cortes, S. et al. Wax: A benign hydrogen-storage material that rapidly releases H2-rich gases through microwave-assisted catalytic decomposition. Sci. Rep. 6, 35315; doi: 10.1038/srep35315 (2016)
17. WO 2018/104712, Oxford University Innovation Limited

1. A process for producing a gaseous product comprising hydrogen, said process comprising exposing a gaseous hydrocarbon to microwave radiation in the presence of a solid catalyst,
wherein the catalyst comprises at least one iron species supported on a support comprising a ceramic material or carbon, or a mixture thereof.

2. A process according to claim 1 wherein the iron species is selected from an elemental iron, an iron alloy, an iron oxide, an iron carbide and an iron hydroxide.

3. A process according to any one of claims 1 and 2 wherein the iron species is selected from elemental Fe, an iron oxide, and a mixture thereof.

4. A process according to any preceding claim wherein the at least one iron species consists of a mixture of elemental metals, metal oxides or mixtures thereof.

5. A process according to any one of the preceding claims wherein the support comprises a ceramic material.

6. A process according to claim 5 wherein the ceramic material is a non-oxygenated ceramic.

7. A process according to claim 5 wherein ceramic material is selected from the group consisting of silicon carbide, boron carbide, tungsten carbide, zirconium carbide, aluminium carbide, aluminium nitride and silicon nitride.

8. A process according to claim 5 wherein the ceramic material is a metal or metalloid oxide.

9. A process according to claim 5 wherein the ceramic material is selected from the group consisting of oxides of aluminium, silicon, titanium or zirconium, and mixtures thereof.

10. A process according to claim 5 wherein the ceramic material is selected from an aluminium oxide, a silicon oxide and a silicon carbide.

11. A process according to any one of claims 1 to 4 wherein the support comprises a carbon material.

12. A process according to claim 11 wherein the carbon material is selected from activated carbon, graphene, graphite, carbon black and carbon nanoparticles (e.g. carbon nanotubes).

13. A process according to any preceding claim wherein the catalyst comprises of elemental Fe supported on silicon carbide, elemental Fe supported on Al₂O₃, elemental Fe supported on SiO₂.

14. A process according to any preceding claims wherein the catalyst further comprises carbon.

15. A process according to claim 14 wherein the carbon material is selected from activated carbon, graphene, graphite, carbon black and carbon nanoparticles (e.g. carbon nanotubes).

16. A process according to any preceding claim wherein the catalyst has an iron loading of up to about 50 wt. %.

17. A process according to claim 16 wherein the iron loading is from about 2 wt. % to about 10 wt. %, preferably about 5 wt. %.

18. A process according to any one of the preceding claims wherein the gaseous hydrocarbon is selected from methane, ethane, propane and butane.

19. A process according to any one of the preceding claims wherein the gaseous hydrocarbon comprises methane.

20. A process according to any one of the preceding claims wherein the gaseous hydrocarbon comprises at least about 90 wt. % of methane.

21. A process according to any one of the preceding claims wherein the process is conducted in the absence of oxygen and/or water.

22. A heterogeneous mixture comprising a solid catalyst in intimate mixture with a gaseous hydrocarbon wherein the catalyst comprises at least one iron species supported on a support comprising a ceramic material or carbon, or mixture thereof.

23. A microwave reactor comprising a heterogeneous mixture, said mixture comprising a solid catalyst in intimate mixture with a gaseous hydrocarbon, wherein the catalyst comprises at least one iron species supported on a support comprising a ceramic material or carbon, or mixture thereof.

24. A fuel cell module comprising a (i) a fuel cell and (ii) a heterogeneous mixture comprising a solid catalyst in intimate mixture with a gaseous hydrocarbon wherein the catalyst comprises at least one iron species supported on a support comprising a ceramic material or carbon, or mixture thereof.

25. A vehicle or an electronic device comprising a fuel cell module according to claim 25.
